(19) United States
(12) Patent Application Publication
(10) Pub. No.: US 2012/0116893 A1
(43) Pub. Date: May 10, 2012

(54) AUCTION-BASED SHIPMENT ADVERTISING

(76) Inventor: William R. Murray, JR., Dublin, CA (US)

(21) Appl. No.: 12/942,966

(22) Filed: Nov. 9, 2010

(51) Int. Cl. G06Q 30/00

(52) U.S. Cl. 705/14.71

(57) ABSTRACT

A marketing system and method for interacting with existing commerce processes for delivering relevant, timely, and useful marketing information to a consumer. A method implemented using a computing system includes (a) obtaining, using the computing system, a set of shipment parameters for a shipment to be delivered to a receiver; (b) auctioning electronically a shipment addition responsive to the set of shipment parameters wherein the auctioning identifies a selected content provider from a plurality of content providers as a winning content provider; (c) acquiring, from the winning content provider, a particular shipment addition for the shipment addition; (d) producing a specified shipment addition including the particular shipment addition; and thereafter (e) associating the specified shipment addition with the shipment wherein the shipment and the specified shipment addition are to be shipped to the receiver.

### BACKGROUND OF THE INVENTION

The present invention relates generally to advertising, and more particularly to inclusion of market-determined third party advertising content in manufactured products.

Advertising is well-known in many forms and in many contexts. Some of the types of advertising systems and methods include direct negotiation between a content distributor and an advertiser regarding placement terms of advertisements in the content distributor's products. Additionally, there are many types of dynamic advertising systems, such as for example Google's AdSense. AdSense is an advertising program run by Google.

One goal of marketing has been targeted advertisements, particularly efforts to present useful information to a prospective purchaser with some a priori sense that the presented information is, in fact, useful to the particular purchaser. Efficiency with marketing budgets is improved to the degree with appropriate messages can be provided to the right purchaser at the right time.

In the world of commerce, there currently exists the model of a purchaser ordering a product from a manufacturer (directly or indirectly) and receiving that product in a shipment from a carrier of some type. There are other models of course, but the context of the present invention is of a shipment being prepared and delivered by a third party for a receiver. In this model, a large retailer is known to provide “blow in” cards for various shipments. The content of the cards are not dynamically chosen responsive to any information regarding the shipment.

In this model, there are many opportunities to collect information about the receiver and to better tailor and target information for the receiver that is relevant, timely, and useful.

What is needed is a marketing system and method for interacting with existing commerce processes for delivering relevant, timely, and useful marketing information to a consumer.

### BRIEF SUMMARY OF THE INVENTION

Disclosed is a marketing system and method for interacting with existing commerce processes for delivering relevant, timely, and useful marketing information to a consumer. A method implemented using a computing system includes (a) obtaining, using the computing system, a set of shipment parameters for a shipment to be delivered to a receiver; (b) auctioning electronically a shipment addition responsive to the set of shipment parameters wherein the auctioning identifies a selected content provider from a plurality of content providers as a winning content provider; (c) acquiring, from the winning content provider, a particular shipment addition for the shipment addition; (d) producing a specified shipment addition including the particular shipment addition; and thereafter (e) associating the specified shipment addition with the shipment wherein the shipment and the specified shipment addition are to be shipped to the receiver.

An apparatus includes a computing system for obtaining and storing a set of shipment parameters for a shipment to be delivered to a receiver; an automated auction system, coupled to the database, for auctioning electronically a shipment addition responsive to the set of shipment parameters wherein the auctioning identifies a selected content provider from a plurality of content providers as a winning content provider; a communication system for acquiring, from the winning content provider, a particular shipment addition for the shipment addition; an automated system for producing a specified shipment addition including the particular shipment addition; and an automated system for associating the specified shipment addition with the shipment wherein the shipment and the specified shipment addition are to be shipped to the receiver.

There are many advantages of the present invention including on demand, just-in-time, and pre-manufactured systems and methods for a commerce partner to access additional value from a shipment. The systems and methods help to deliver relevant, timely, and useful marketing information to a consumer, what consumers indicate that they want. Some of these systems permit a small business to access marketing and distribution modalities that would be difficult, if at all possible under conventional systems.

Embodiments of the present invention include an on demand ad platform for boxes being shipped and bill stuffers. The system is a marketplace for bidding on placing ads on the outside of the box a shipper is shipping (i.e. inkjet application on shipping line or sticker) or for inserting ads into the box or printing them onto the packing slip. There is also a version for invoices/bills.

An example would be Amazon shipping hundreds of millions of boxes per year. Currently they have blow in cards with ads for other companies. The system and methods would allow Amazon to participate in a marketplace for placing ads into the box and on the outside of the box and maximize their revenues and give advertiser's a way to talk to targeted users. The bidding to be in a given box would tie to, depending upon implementation, any economically important parameter associated with any of the commerce, shipping, distribution, customer, and the like.

Other benefits and features of the present invention will be apparent upon a review of the drawings, specification, and claims.

### BRIEF DESCRIPTION OF THE DRAWINGS

FIG. 1 is a schematic block diagram of a real-time auction marketing system;

FIG. 2 is a flowchart of a process 200 for a preferred embodiment of the present invention.

### DETAILED DESCRIPTION OF THE INVENTION

The present invention relates to a marketing system and method for interacting with existing commerce processes for delivering relevant, timely, and useful marketing information to a consumer. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

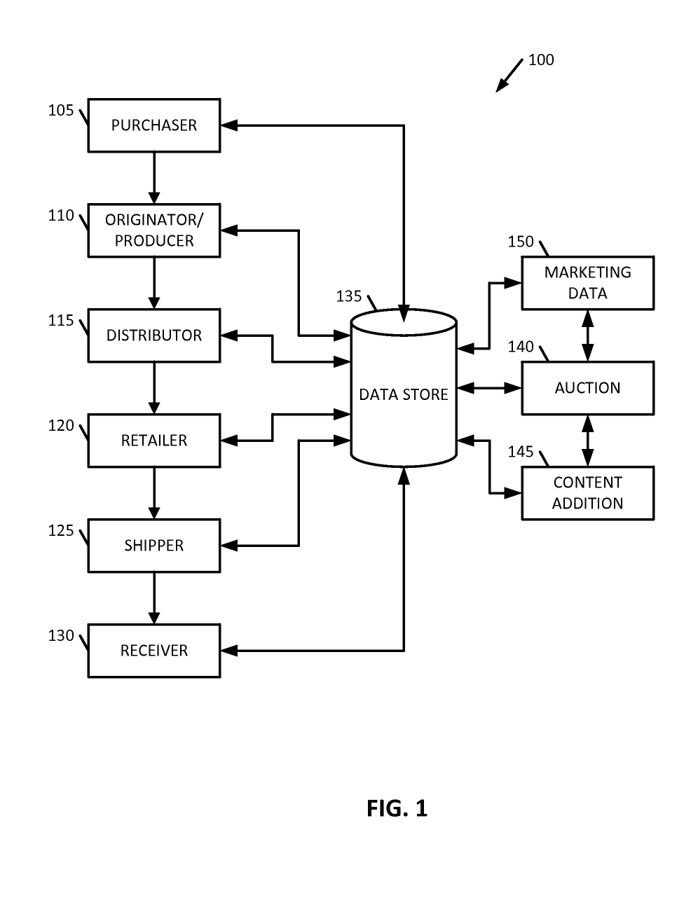

FIG. 1 is a schematic block diagram of a real-time auction marketing system 100. System 100 is largely automated and implemented by a microprocessor/microcontroller/microcomputer executing instructions retrieved from a memory, with input and output functions implemented by interface processes also supported by a microprocessor/microcontroller/microcomputer executing instructions retrieved from a memory. In the preferred implementation, the various components are distributed and data is intercommunicated using various networking and communication protocols. These devices, functions, processes, components, protocols, and the like are not directly part of the present invention which uses these advantageously as needed or desired.

System 100 includes a commerce stream including one or more of entities 105-130. A purchaser 105 is said to be an initiator of a purchase of a good or service. This includes conventional goods and services conventionally bought online or over the telephone. In addition, the purchaser has various accounts that generate statements regarding a status or changes in those accounts, and the person is said to be a purchaser in these contexts for the purposes of the present invention. These accounts would include credit card, banking, investment, utility, purchasing history, and other types of records periodically generated on behalf of the purchaser.

Purchaser 105 “purchases” the good or service from an originator/producer 110. The purchase may be direct or indirect, but it identifies a particular set of goods and/or services from originator 110. The particular set of goods/services may include one or more standard items, or customized items for the purchaser. They may be stock items or built on-demand. The purchase typically includes generation of a statement or other printed matter reflecting some administrative and/or account related characteristic of the shipment, payment, or the like. Production and origination typically have different functions but are both included together, representing a point-of-contact for the purchaser. As noted herein, the commerce stream varies widely and the depicted stream is representative and not taken as limiting the scope of the present invention.

In the commerce channel, there are sometimes one or more middlemen to facilitate the marketing and distribution of the goods and services. They may be wholesalers, distributors, warehousers, fulfillment centers, online and offline retailers, and the like. All of these functions are summarized by a distributor 115 and a retailer 120 shown in FIG. 1.

System 100 includes a shipper 125, which may represent be a standalone courier/delivery/postal service or an integrated service. Any particular distributor 115/retailer 120 may use one or more shippers 125.

A receiver 130 is the ultimate entity designated for receipt of the shipment. Receiver 130 may often be purchaser 105, but is not always so, which is why system 100 includes two separate designations of these entities. Receiver 130 may be a direct receiver (that is, a person, business, or the like) that is identified as the recipient. In some cases, the idea of an indirect receiver is useful as receiver 130 may encompass more than a single person or a single addressee (the indirect receiver is someone in a particular relationship with the direct receiver—a household member, workgroup, or other organization or the like—who has access to the shipment and shipment addition. Additionally in the case of a receiver identifying a collection of receivers, different parameters may be useful, such as the case when the receiver is a business entity rather than a person. The demographics and other data described herein may be better adapted by using statistical representations of trends, likes and the like associated with one or more relevant groups in the business enterprise. Thus receiver may include direct or indirect receivers

The purchase of the set of goods or services initiates the real-time auction marketing process. Data is collected from/about each of the entities 105-130 and accumulated in a data store 135. Data store 135 is preferably a high performance database supported by a computing system. Particular details of the implementation of data store 135 will be dependent upon the amount of data to be processed. In the preferred embodiment, it is desired that the data gathering and processing occur in time sensitive to the needs of the commerce stream represented by entities 105-125 from a time of placement of an order to its shipment. Therefore preferred data store 135 implementations have minimal impact upon the shipment being delivered to receiver 130. As explained in more detail below, results of some processing of data from data store 135 may be needed earlier in the commerce stream, with processing responsive to the point at which the processing results are needed.

Data store 135 collects and indexes data from one or more of the entities in the commerce stream, the particular data and the particular entities varying based upon implementation. For example, the collected data may include: (1) the products in the shipment; (2) ship to info (e.g., zip code or state/city or more detailed street); (3) value of the shipment; (4) demographics of a user, including income, value/type of property at shipping address, property taxes, other information about city/town/county, employment, children or other residents at shipping address, number of people at shipping address, other personal information obtainable from public or private sources, customer, end users and the like; (5) shipping method; (6) user purchase history (knowledge of number/type/quantity/price of other goods/services purchased); (7) URL they came from before merchant site (e.g., an AOL users); (8) other information gleaned from ad networks and other data sources about that purchaser/receiver; (9) user email address and email domain (i.e. apple.com); (10) space available for advertising; (11) color/B&W; (12) type of ad space available—in box, on box; (13) the user themselves (a car dealer targeting a user); (14) the originator/shipper—so people pay (e.g., bid) more for Amazon; among other types of data and demographic information. For purposes of the present application, the term electronic commerce indicia includes parameters such as the URL of a website visited before, or referring to, a website where the shipment is originated, e-mail address and portions thereof like top-level domain and the like, and other information gleaned from ad networks and other data sources about that purchaser/receiver/originator.

In the preferred embodiments, it is the case that one class of shipment addition includes co-generated content in which a particular shipment addition is received from a winning party (the actual receipt/generation of which may before, contemporaneous, or after identification any single or group of content providers as “winners” in the sense of being selected to provide content for shipment addition(s)) and co-generated with generation of other shipment contents. Cogeneration in this context includes cogeneration in time but could be done in different locations and merged in the shipment. Non cogenerated shipment additions may be created before or after generation of other shipment contents and merged into the shipment as well.

In the preferred embodiments, it is also the case that a single shipment may have multiple shipment additions, each may auctioned singly and/or in combination, and a single winning content provider may provide content for one or more shipment additions, and/or multiple winning content providers may provide content for one or more shipment additions.

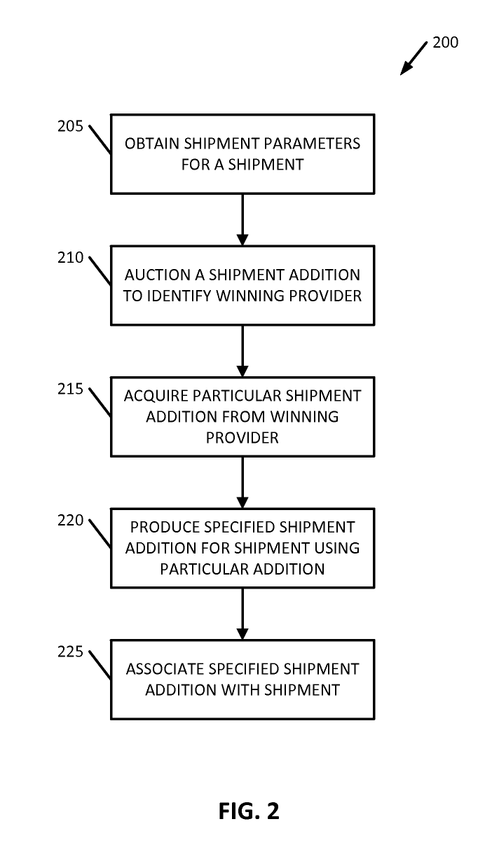

FIG. 2 is a flowchart of a process 200 for a preferred embodiment of the present invention. Process 200 is, preferably, implemented by one or more computing systems including a processor and memory storing processor executable instructions. Process 200 begins with step 205 to obtain shipment parameters for a shipment. The shipment of the preferred embodiment includes a tangible object/container conveyed using a shipper. The shipment, and or its contents, may have been provided in advance, on demand, just-in-time or the like, by any number of commerce partners. The preferred embodiment focuses predominately on the commerce partner that actually places the shipment into the shipping process by delivery to a shipper. In some embodiments, it may be possible for a shipper to implement certain features of the present invention by providing devices to apply indicia (directly or indirectly) to an outside of the shipment. In some cases, there may be “nested” shipments and some embodiments may treat each hierarchy level different from other levels, as each level may be shipped by a different shipper, with different originators and/or receivers. Related to this, but somewhat different is the situation that certain shippers/shipments include nested packaging for the same shipment (e.g., double-box/wrap).

The shipment parameters are collected by some computer system into a database, a shipper computing system or moderator computing system (which may include a network or cloud of computing resources). The parameters are described herein and may include a wide range of information related to and/or derived from the shipment and its commerce partners including the originator/purchaser/receiver.

Next at step 210, process 200 conducts an auction of a shipment addition for the shipment. There are many different auction systems, the preferred embodiments contemplate an automated auction system that may be initiated and concluded among a party having access to the database with the shipment parameters and one or more content providers desiring to provide a shipment addition for the shipment. As noted herein, any single shipment may have multiple prospective shipment additions and there may be one or more auctions for the various available shipment additions. By some process associated with the auction, one or more prospective content providers are identified as “winning” content providers.

Process 200, at step 215, acquires particular shipment addition(s) from each winning content provider, the particular shipment addition consistent with the auction and lot won. Following step 215, process 200 implements step 220 to produce a specified shipment addition for the identified shipment from the one or more particular shipment additions provided from the one or more winning content providers. Many different commerce partners are candidates to perform this step, and in some implementations different commerce partners may perform this step. For example, the distributor who places the shipment directly in possession of a shipper is preferably the party that produces the specified shipment addition (insert and the like) for packing with other elements of the shipment. One of many different permutations includes having a third-party conduct the auction and generate an insert for the distributor, for example, rather than the distributor performing this step.

Next at step 225, process 200 associates the specified shipment addition with the proper shipment. The method of association is dependent upon the nature of the specified shipment addition as noted herein. Those shipment additions may be of many different types and the association is therefore commensurate and appropriate.

The embodiments of the present invention contemplate different revenue models depending upon various factors and implementations. The embodiments of the present invention implement these various models for participation in the commerce stream and the associated targeted marketing.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A method implemented using a computing system, the method comprising the steps of:
(a) obtaining, using the computing system, a set of shipment parameters for a shipment to be delivered to a receiver;
(b) auctioning electronically a shipment addition responsive to said set of shipment parameters wherein said auctioning identifies a selected content provider from a plurality of content providers as a winning content provider;
(c) acquiring, from said winning content provider, a particular shipment addition for said shipment addition;
(d) producing a specified shipment addition including said particular shipment addition; and thereafter
(e) associating said specified shipment addition with said shipment wherein said shipment and said specified shipment addition are to be shipped to said receiver.

2. The method of claim 1 wherein said shipment parameters include one or more parameters selected from the group consisting of a shipment content, a value of said shipment content, geographic information of said receiver, shipment-address derived information, demographic information of said receiver, a shipping method for said shipment, a shipping history of said receiver, demographic information of a purchaser of said shipment content, information regarding supported shipment additions, characteristics of supported shipment additions, information regarding supported associations of said shipment addition relative to said shipment, information regarding a shipper of said shipment, information regarding a capacity for said shipping addition, information regarding a producer of said shipment, preferences of said receiver, background information, including personal/education/employment/career/title or other information about said receiver, an originator of said shipment content, a relationship between said originator and said receiver, a relationship between a producer and said receiver, a purchasing history of said purchaser, a purchasing history of said receiver, a relationship between a producer and said receiver, brand names of components/subassemblies of said shipment content, associated with electronic commerce indicia of originator, electronic commerce indicia of receiver, and combinations thereof.

3. The method of claim 1 wherein said shipment addition includes one or more additions selected from the group consisting of an insert for addition inside said shipment, a content addition for co-generation with other content generated by a shipper of said shipment included in a content of said shipment, a content addition for co-generation with other content generated by a producer of said shipment, a content addition for co-generation with said content of said shipment generated by an originator of said content, a pre-manufactured item for addition to said shipment, a content addition for application to a shipping container of said shipment, and combinations thereof.

4. The method of claim 1 wherein said association of said shipment addition with said shipment includes one or more processes selected from the group consisting essentially of placement of said shipment addition inside a shipping container of said shipment, generation of said shipment addition directly on said shipping container, generation of said shipment addition on an indicia applied to said shipping container, and combinations thereof.

5. An apparatus, comprising:
a computing system for obtaining and storing a set of shipment parameters for a shipment to be delivered to a receiver;
an automated auction system, coupled to said database, for auctioning electronically a shipment addition responsive to said set of shipment parameters wherein said auctioning identifies a selected content provider from a plurality of content providers as a winning content provider;
a communication system for acquiring, from said winning content provider, a particular shipment addition for said shipment addition;
an automated system for producing a specified shipment addition including said particular shipment addition; and
an automated system for associating said specified shipment addition with said shipment wherein said shipment and said specified shipment addition are to be shipped to said receiver.

6. The apparatus of claim 5 wherein said shipment parameters include one or more parameters selected from the group consisting of a shipment content, a value of said shipment content, geographic information of said receiver, shipment-address derived information, demographic information of said receiver, a shipping method for said shipment, a shipping history of said receiver, demographic information of a purchaser of said shipment content, information regarding supported shipment additions, characteristics of supported shipment additions, information regarding supported associations of said shipment addition with said shipment, information regarding a shipper of said shipment, information regarding a capacity for said shipping addition, information regarding a producer of said shipment, preferences of said receiver, an originator of said shipment content, a relationship between said originator and said receiver, a purchasing history of said originator, a purchasing history of said receiver, electronic commerce indicia of originator, electronic commerce indicia of receiver, and combinations thereof.

7. The apparatus of claim 5 wherein said shipment addition includes one or more additions selected from the group consisting of an insert for addition inside said shipment, a content addition for co-generation with other content generated by a shipper of said shipment included in a content of said shipment, a content addition for co-generation with other content generated by a producer of said shipment, a content addition for co-generation with said content of said shipment generated by an originator of said content, a pre-manufactured item for addition to said shipment, a content addition for application to a shipping container of said shipment, and combinations thereof.

8. The apparatus of claim 5 wherein said association of said shipment addition with said shipment includes one or more processes selected from the group consisting essentially of placement of said shipment addition inside a shipping container of said shipment, generation of said shipment addition directly on said shipping container, generation of said shipment addition on an indicia applied to said shipping container, and combinations thereof.
